(19) United States
(12) Patent Application Publication
(10) Pub. No.: US 2006/0199611 A1
(43) Pub. Date: Sep. 7, 2006

(54) Portable device with calendar application

(75) Inventor: Antti Eskelinen, Jyvaskyla (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/070,249

(22) Filed: Mar. 3, 2005

(51) Int. Cl. H04M 1/00; H04B 1/38

(52) U.S. Cl. 455/556.2; 455/566

(57) ABSTRACT

A mobile telephone includes a calendar application. A calendar entry can be entered either using the phone or using a remote terminal, such as a PC or another phone. Each calendar entry can have associated with it one or more media items. Media items can be audio clips, images, animations or videos. When an alarm associated with the calendar event occurs, the media item is rendered. Thus, images can be displayed, which is particularly advantageous for people whom are unable to read. Audio content can provide additional information, especially for the blind and visually impaired.

This invention relates to portable devices including calendar application programs. It is particularly concerned with hand-portable devices such as mobile or cellular telephones and personal digital assistants and the like.

It is known for entries in calendar applications to be displayed with an icon which indicates whether an alarm is set. The icon may take the form of a bell, for instance, which is shown if an alarm is set and is not shown if no alarm is set. JP-A-59010879 discloses something similar. It is known also, from JP-A-55087082, for different tones to be used in connection with alarms on different days of the week on an electronic watch.

The functionality that can be provided with mobile telephones continues to grow quickly. Existing functionality also is being enhanced with each successive product release. For instance, U.S. Pat. No. 5,784,001 discloses a phone that can automatically ‘read’ a received message and display images relating to keywords in this messages along with the text of the message.

It has been popular for many years to provide mobile or cellular telephones and personal digital assistants (PDAs) with calendar applications. Calendar entries can be made manually, using a keypad and/or other input device, and in some devices it is possible to receive calendar entries sent from, for example, friends and family members. Calendar entries can include alarms, so that the user is notified at some appropriate time. Depending on the device, an alarm may be set to a predetermined time prior to the calendar entry, and may be snoozed to reoccur at a later time if desired.

However, although modern mobile telephones typically have ample processing and memory resources, calendar applications have not developed to the same extent as other applications and still are used by only a small percentage of mobile phone users.

Also, because reading ability and a basic technological literacy is required to use mobile telephones effectively, they tend not to be used by people who are visually impaired or blind, children who are before reading age, by elderly persons, or by persons with learning difficulties or other mental disability.

According to a first aspect of the invention, there is provided a portable device comprising: an output transducer; a processor; and a calendar application program, the calendar application program being: operable when running on the processor to store at least first and second calendar entries, the first calendar entry having associated therewith a first media item, and the second calendar entry having associated therewith a second media item, the first media item being different to the second media item, and content provided by the first media item being different to content provided by the second media item; and responsive to a detection that a current time corresponds to an activation time of one of the first and second calendar entries to render content provided by the associated media item via the output transducer.

According to a second aspect of the invention, there is provided A portable device comprising:
an output transducer;
a memory, the memory being provided with plural media items, each media item providing content;
a processor; and
a calendar application program, the calendar application program being:
   operable when running on the processor to store at least two calendar entries, each calendar entry including a respective media item identifier; and
   responsive to a detection that a current time corresponds to an activation time of one of the plural calendar entries:
      to extract from the memory the media item corresponding to the media item identifier stored with the calendar entry, and
      to use the extracted image media item to render the content provided thereby via the output transducer.

The invention allows calendar entries to be associated with images and/or audio that can convey to the user what the calendar entry concerns, without them needing to read any text. Thus, the invention can make mobile telephones and like devices useable by persons whom may not otherwise be able to use them. The invention can also provide increased usability of mobile telephones and like devices to other persons.

### BRIEF DESCRIPTION OF THE DRAWINGS

Embodiments of the invention will now be described by way of example with reference to the accompanying drawings, of which:

FIG. 1 illustrates the exterior of a mobile or cellular phone according to the invention;

FIG. 2 shows certain components of the FIG. 1 phone and their interconnections;

FIG. 3 shows setting up a calendar entry with an alarm on the FIGS. 1 and 2 phone;

FIGS. 4 and 5 show how a calendar entry can be entered onto a phone remotely; and

FIG. 6 shows how the FIGS. 1 and 2 phone operates to announce a calendar entry alarm.

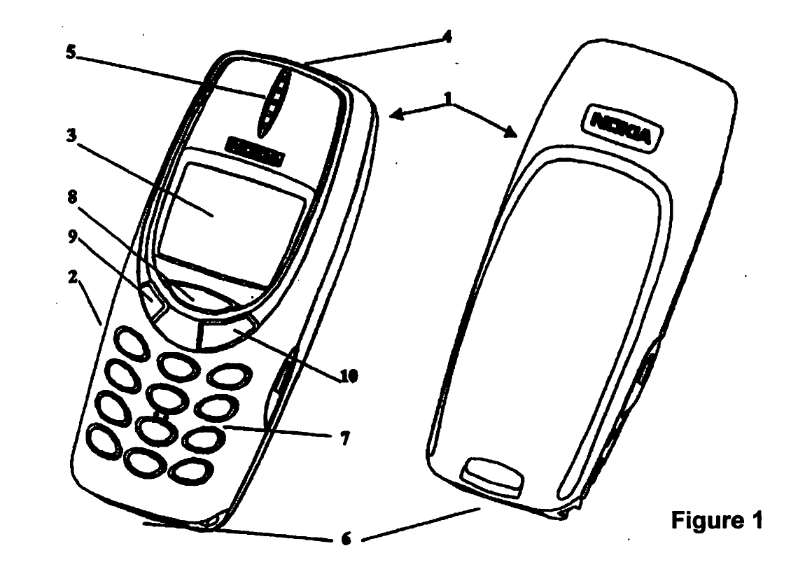

Referring to FIG. 1, the phone, which is generally designated by 1, comprises a user interface having a keypad 2, a display 3, an on/off button 4 (present on the top of the phone and therefore not visible in the present view), a speaker 5, and a microphone 6 (openings present in the bottom of the phone and therefore not visible in the present view). The phone 1 is adapted for communication via one or more different networks, such as a GSM 900/1800 MHz network, or a third generation (3G) network, the PCN network and so on.

The keypad 2 has a first group 7 of keys as alphanumeric keys, one softkey 8, a cursor navigation key 10 (scroll up/down), and a “clear” key 9 for erasing letters in text in the display 3, for moving up levels in the menu structure and for rejecting calls. The present functionality of the soft key 8 is shown in separate fields (softkey-label) in the display 3 just above the softkey 8. The softkey 8 is a multifunction key and its present function depends on the state of the phone 1. The softkey 8 gives access to the menu, the phonebook, and call handling and other applications.

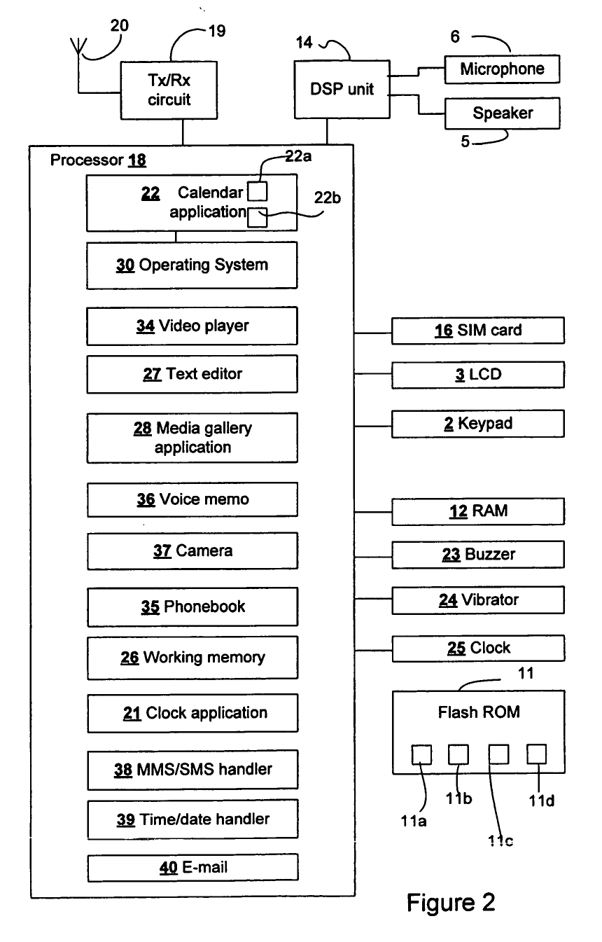

FIG. 2 schematically shows some important parts of the phone 1. A part shown in both FIGS. 1 and 2 uses the same reference numeral. A processor 18 controls the communication with the network via a transmitter/receiver circuit 19 and an internal antenna 20.

The microphone 6 transforms speech into analogue signals, which are A/D converted in an A/D converter (not shown) before being encoded in a digital signal processing (DSP) unit 14. The encoded speech signal is transferred to the processor 18, which inter alia supports the GSM and/or 3G terminal software. The processor 18 also forms the interface to the peripheral units of the apparatus, including a RAM memory 12 and a Flash ROM memory 11, a SIM card 16, a clock 25, the display 3 and the keypad 2 (as well as data, power supply, etc). The DSP unit 14 speech-decodes the signal, and the result is transferred from the processor 18 to the speaker 5 via a D/A converter (not shown).

The processor 18 includes a calendar application 22. This has well-known calendar functionality. It is operable to store calendar entries, which are controllable to have alarms associated with them. The calendar application 22 is implemented as a software application implemented into the phone software of the phone 1. The calendar application 22 is operable to communicate with each of the following software applications which are existing in the phone 1: a text editor 27, a working memory 26, a clock application 21, an operating system (OS) 30, a video player 34, a phone book 35, a voice memo application 36, a camera application 37, a short message service (SMS)/multimedia message service (MMS) handler application 38, a time/data handler application 39, a media gallery application 28 and an email application 40. Each of these software applications is operable to perform the tasks usual for such applications, and co-operates with the relevant hardware devices in an appropriate manner. The voice memo application 36 for instance can be used to record audio clips, which are then stored in the flash ROM 11. Two such audio clips are illustrated at 11a and 11b in FIG. 2. These audio clips 11a, 11b are media items. Similarly, the camera application 37 can be used to capture still images, one of which is illustrated as being stored at 11c in the Figure. This still image 11c is a media item. Videos comprising images and optionally audio also can be produced by the phone 1. One such video is shown at 11d in the Figure. This video 11d is a media item.

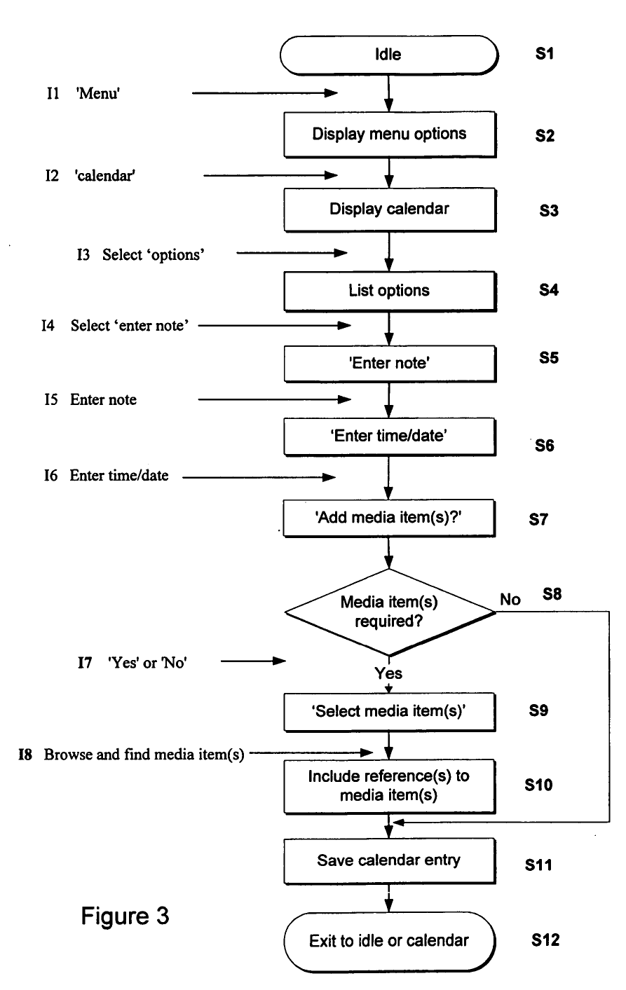

Generally speaking, the calendar application 22 operates to allow the input of calendar entries, to store the calendar entries in the working memory 26, and to determine when an alarm should be announced, which depends on information contained within the calendar entry itself. Stored calendar entries are illustrated at 22a and 22b in FIG. 2. The method for the entering of a calendar entry on the phone 1 will now be described be described with reference to FIG. 3.

Referring to FIG. 3, the phone 1 starts in an idle state at S1. Following an input I1 by a user seeking the menu of the phone 1, the menu options are displayed at step S2. Following the selection of the calendar menu option by input I2, the phone 1 displays the initial page of the calendar application at step S3. What this is depends on the particular calendar application, and perhaps also on user defined settings. The initial page may be a week view, a day view or a month view, etc. The softkey 8 allows options associated with the calendar application to be displayed on the display 3 in a selectable manner. Following an input I3 constituting depression of the softkey 8, the phone 1 displays a list of available calendar options at step S4. One of these options is an option which allows the storing of a new calendar entry. This option is selected by way of an input I4, following which the phone 1 displays at step S5 text requesting the entering of a note to be associated with the calendar entry. Following entry of a note at input I5, the phone 1 then displays at step S6 the text ‘Enter time/date’. The phone 1 then requires a time and date to be entered or selected at input I6. Following this, the phone 1 displays at step S7 the text ‘Add media item(s)?’. The phone 1 then requires a user input I7. If the user selects that a media item is required to be added to the calendar entry, this results in a “yes” answer to the question of step S8, and operation progresses to step S9. The text ‘Select media item(s)’ is displayed at step S9. The user then is required to browse and select one or more media items at input I8. The user may select one or more of the audio clips 11a, 11b, and/or the image 11c. Alternatively the user may select the video 11d. The user may alternatively or in addition select one or more media items located remotely, for instance using a WAP browser (not shown) to obtain an image, animation, audio clip and/or video from a server (not shown) connected to the Internet. At least one media item preferably includes at least one image. It may be for instance a single image, an animation comprising a series of still images, or a video clip. A video clip may or may not include an audio component. The media item or items may instead include only audio. A reference to each of the media items then is attached to the calendar entry at step S10. If a media item is one that is located remotely, it may be downloaded to the phone 1, in which case the reference relates to the local copy, or the reference may include, for instance, the URL that includes the media item. Following step S10 or following a negative determination from step S8, progression is made to step S11. The calendar entry is saved at step S11, along with any reference(s) included at step S10. Following step S11, progression is made to step S12 where the phone 1 either exits to an idle state or to the calendar application.

Typically, the media item or items associated with a calendar entry include either a single video with audio media item, a single audio content media item, a single image content item, or a single audio content media item and a single image content item. In this way, a maximum of one image content component is present, so there will not be contention even without sequencing. Similarly, a maximum of one audio content component is present, so there will not be overlapping of audio even without sequencing.

It is envisaged that calendar entries including references to media items will be entered by carers of people who are visually impaired or blind, elderly people or people with learning difficulties, and by parents, guardians etc. of young children.

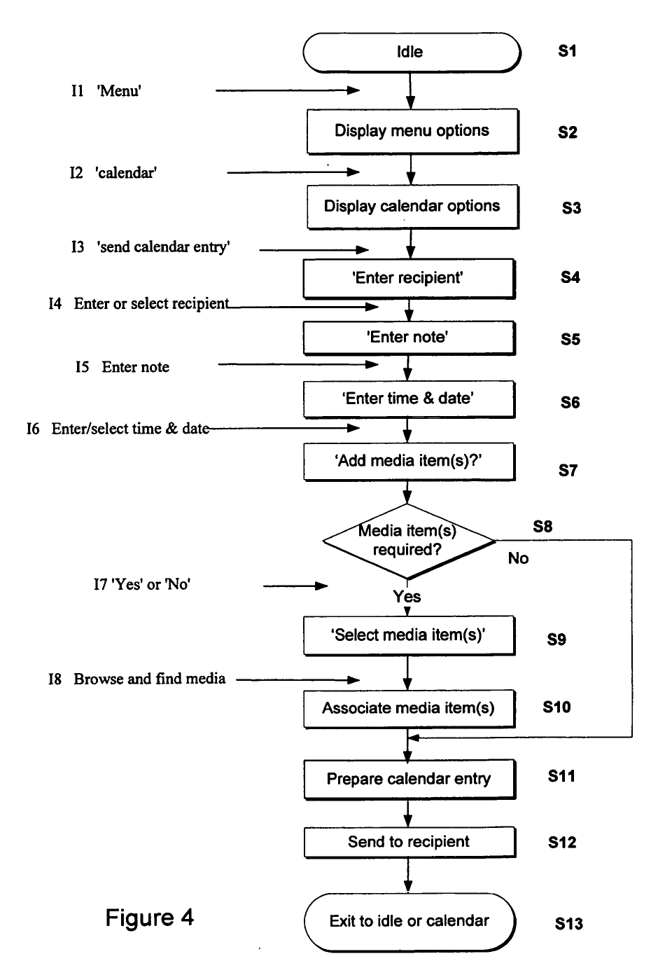

The remote setting up of a calendar entry on the phone 1 will now be described with reference to FIG. 4. Referring to FIG. 4, an operation is shown operating on a device which is remote from the phone 1. The remote device may take any form, such as, for example an Internet connected personal computer or the like. For the sake of convenience, though, it is assumed here that the operation of FIG. 4 is performed by a phone like the phone 1.

The operation commences at S1, where the phone is in idle mode. Following an input I1 by a user indicating that a menu is required, the phone displays the menu options at step S2. Following an input I2 which is the selection of the calendar menu option, the phone displays the calendar options at step S3. One of the calendar options displayed at S3 is an option allowing the sending of a calendar entry. Following selection of this option at input I3, the phone displays at step S4 that the recipient of the calendar entry is to be entered. An input I4 comprises either the entering of or the selection of the recipient of the calendar entry (by way of the telephone number, e-mail address or other identifier), following which at step S5 the phone displays the text ‘Enter note’ requesting the entering of a note to be associated with the calendar entry. Following the entering of a note by way of an input I5, the phone 1 then displays at step S6 the text ‘Enter time/date’. The phone 1 then requires a time and date to be entered or selected at input I6. At step S7, the phone 1 then displays the text ‘Add media item(s)?’. A yes or no input then is required. If an input I7 indicates that such a media item is required to be added, then a question at step S8 provides a positive result and the operation progresses to step S9. Here, the text ‘Select media item(s)’ is displayed. The user then is required to browse and select one or more media items at input I8. The user may select one or more of the audio clips 11a, 11b, and/or the image 11c. Alternatively the user may select the video 11d. The user may alternatively or in addition select one or more media items located remotely, for instance using a WAP browser (not shown) to obtain an image, animation, audio clip and/or video from a server (not shown) connected to the Internet. At least one media item preferably includes at least one image. It may be for instance a single image, an animation comprising a series of still images, or a video clip. A video clip may or may not include an audio component. The media item or items may instead include only audio. Each media item then is associated with the calendar entry at step S10. Following step S10, or if a negative determination is made at step S8, the operation progresses to step S11, where the calendar entry is prepared. Preparation involves combining the note entered by way of the input I5, the time and date entered by way of the input I6, any media item selected by way of input I8 and an indication of the recipient entered by way of input I4. If a media item is one that is located remotely, it may be downloaded to the phone 1, in which case a copy of the media item is attached, or the preparation of the calendar entry may involve including, for instance, the URL that includes the media item. Optionally, the identity of the recipient may be omitted from the calendar entry. At step S12, the calendar entry is sent to the recipient identified by the input I4. Sending may occur in any suitable manner, for example, by SMS, email, or through any other suitable delivery mechanism. Following the sending of the calendar entry at step S12, the operation progresses to step S13, where the phone exits to an idle state or to the calendar application.

Typically, the media item or items associated with a calendar entry include either a single video with audio media item, a single audio content media item, a single image content item, or a single audio content media item and a single image content item. In this way, a maximum of one image content component is present, so there will not be contention even without sequencing. Similarly, a maximum of one audio content component is present, so there will not be overlapping of audio even without sequencing.

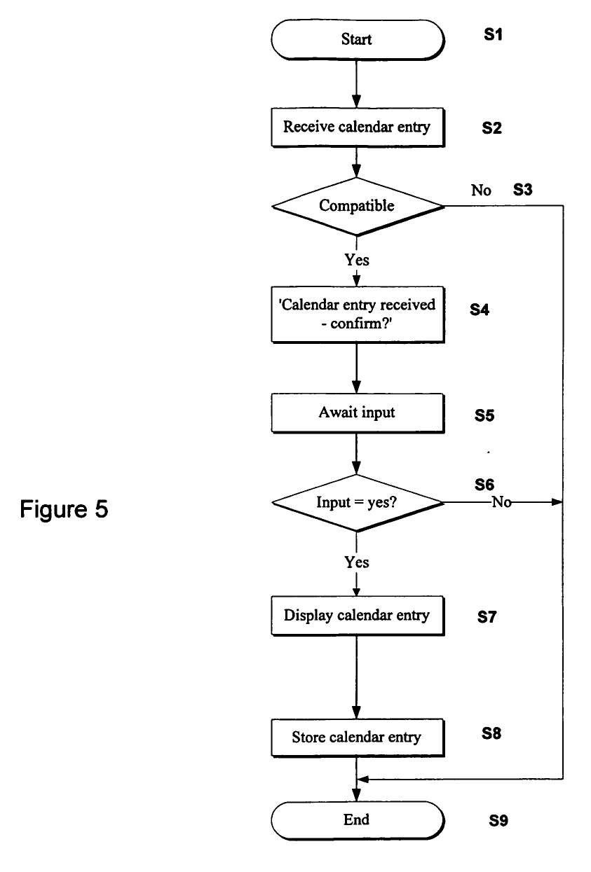

FIG. 5 illustrates operation of the phone 1 when receiving a calendar entry such as the calendar entry generated and sent by the operation of FIG. 4. Referring to FIG. 5, the operation begins at step S1, in which the phone 1 may or may not be in an idle mode. A calendar entry is received at step S2, following which the phone 1 at step S3 determines whether or not the calendar entry is compatible with the capabilities of the phone. The calendar entry will not be compatible if, for example, one or more media items are not in a format which the phone 1 can properly handle. If compatibility is found in step S3, the operation proceeds to step S4, where the phone 1 requests the user to confirm that the calendar entry is to be processed and stored in the phone. An input from the user is awaited at step S5, following which it is determined at step S6 if a positive input has been received. If a user has made a positive input, progression is made to step S7, where the calendar entry is displayed. Alternatively, the phone 1 may be arranged to be settable such that calendar entries received are entered automatically, without requiring user confirmation. The phone 1 may be settable such that calendar entries received only from certain specified senders will be entered automatically. Calendar items received from other senders may require user confirmation before they are entered, or alternatively may be rejected automatically. If a calendar item is rejected, this may be communicated to the sender, for instance by replying to the received calendar entry. If a calendar item is automatically entered, then it may not need to be displayed at step S7. Entry of a calendar entry involves storing it in the calendar application 22, and storing any associated media item, at step S8. The calendar entry stored in the calendar application 22 includes a reference to each media item, so that the media items can be identified when the calendar item is announced. The calendar entry appears in the calendar application 22 like any calendar entry entered directly onto the phone 1. Following step S8, the process progresses to end at step S9. If a negative determination is made at step S3 or step S6, the operation progresses directly therefrom to end at step S9.

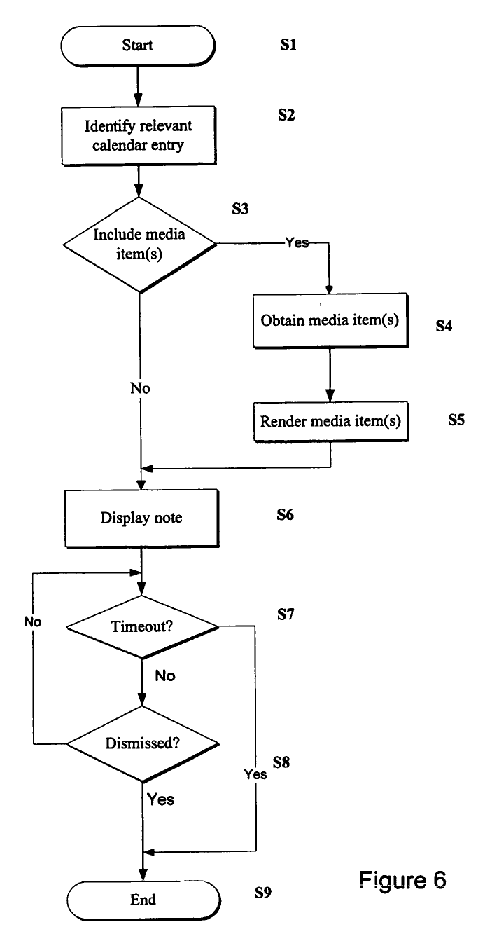

FIG. 6 shows how the phone 1 operates to announce a calendar entry at an appropriate time. With reference to FIG. 6, the operation starts at step S1 when it is determined that the present time is the same as the time set for a reminder on a calendar item stored in the calendar application 22. This may occur in any suitable way. At step S2, the phone 1 then identifies which calendar entry is the relevant one. At step S3, it is determined whether the calendar entry includes a reference to, or is otherwise associated with, one or more media items. On a positive determination, operation proceeds to step S4, where each media item is obtained. This can involve using the reference in the calendar entry to determine the names and/or locations of the media items, and perhaps to copy the media items to volatile memory, such as the RAM 12. Following step S4, the media items are rendered at step S5. Media items comprising images may be rendered over the whole of the display 3, or over just a part thereof. If a media item is a still image, then step S5 constitutes merely displaying the image. If a media item is a sequence of still images, for instance an animation, then the phone 1 displays the still images with a suitable time interval between them. Media items which are audio clips are rendered on the speaker 5. If there is an audio media item and a media item comprising one or more images, then the audio content is rendered via the speaker 5 and the images are rendered via the display 3 simultaneously. If a media item is a video, then step S5 may involve opening the video player application 34 and using the video player to render the video through the display 3 and the speaker 5.

Following the rendering of the media items at step S5 or following a negative determination from step S3, the note associated with the calendar entry is displayed at step S6. If a media item is rendered over only part of the display 3, then the note may be displayed in another part thereof. In this case, it may not be necessary for the rendering of an animation or video to be completed, since the note can be displayed simultaneously with the rendering of the media item. Alternatively, the media item and the note may be rendered sequentially.

Step S7 determines whether a timeout has occurred. If not, step S8 determines if the reminder has been dismissed by user input. If not, then the operation returns to step S7. If the timeout occurs or the reminder is dismissed, then the operation ends at step S9.

Using the above-described phone 1, calendar entries can be associated with media items including images and/or audio suitable for informing the user what the reminder alarm relates to without it being necessary to read the accompanying note. Indeed, in some instances, especially if the user is unable to read, the note can be omitted entirely.

For a calendar entry relating to a mealtime, the media item might be a recording of a person saying “Mealtime—time to eat”, or similar. It may alternatively or in addition be a still image of a plate of food. The image may relate to the particular mealtime, for instance by being an image of breakfast food for a breakfast calendar entry, an image of sandwiches for lunch, and an image of cooked food for an evening meal. Different occasions can be accommodated for by storing different images in the phone 1, and by selecting the appropriate image when setting-up the calendar entry. An animation may involve sequential images with progressively less food shown on the plate, thus illustrating clearly what is supposed to happen to the users food at the time of the calendar entry. Using the camera 37, an image or video can be obtained of the user taking part in the act for which the calendar entry relates. Thus, the calendar entry can be personalised with the user themselves doing the act (e.g. eating) that they are being reminded to do by way of the calendar entry.

The phone 1 may be provided with a number of pre-defined media items. For instance, the predefined media items may indicate “Take your medicine”, “Wash the dishes”, “Get something to eat”, “Call [person]”, etc. through sound and/or images.

The exact means for storing the calendar entries is not critical to the invention. For example, calendar entries may be stored on the flash ROM 11, in the RAM 12 (only while the phone 1 is in a power-on state), or in the working memory 26. The calendar entries may or may not be stored in an area dedicated for use by the calendar application 22. Also, the calendar entries may be provided with the associated media item or items built-in, in which case there is no need for the calendar entries to include references to the associated media items.

What is claimed is:

1. A portable device comprising:
an output transducer;
a processor; and
a calendar application program, the calendar application program being:
operable when running on the processor to store at least first and second calendar entries, the first calendar entry having associated therewith a first media item, and the second calendar entry having associated therewith a second media item, the first media item being different to the second media item, and content provided by the first media item being different to content provided by the second media item; and
responsive to a detection that a current time corresponds to an activation time of one of the first and second calendar entries to render content provided by the associated media item via the output transducer.

2. A device as claimed in claim 1, in which:
the output transducer includes a display; and
at least one of the media items provides content comprising an image.

3. A device as claimed in claim 1, in which:
the output transducer includes a display; and
at least one of the media items provides content comprising a sequence of images.

4. A device as claimed in claim 1, in which:
the output transducer includes a display and a speaker; and
at least one of the media items provides content comprising:
a visual component comprising at least one image, and
an audio component.

5. A device as claimed in claim 1, in which:
the output transducer includes a speaker; and
at least one of the media items comprises audio content.

6. A portable device comprising:
an output transducer;
a memory, the memory being provided with plural media items, each media item providing content;
a processor; and
a calendar application program, the calendar application program being:
operable when running on the processor to store at least two calendar entries, each calendar entry including a respective media item identifier; and
responsive to a detection that a current time corresponds to an activation time of one of the plural calendar entries:
to extract from the memory the media item corresponding to the media item identifier stored with the calendar entry, and
to use the extracted image media item to render the content provided thereby via the output transducer.

7. A device as claimed in claim 6, in which:
the output transducer includes a display; and
at least one of the media items comprises content representing an image.

8. A device as claimed in claim 6, in which:
the output transducer includes a display; and
at least one of the media items comprises content representing a sequence of images.

9. A device as claimed in claim 6, in which:
the output transducer includes a display and a speaker; and
at least one of the media items comprises content representing:
a visual component comprising at least one image, and
an audio component.

10. A device as claimed in claim 6, in which:
the output transducer includes a speaker; and
at least one of the media items comprises audio content.

11. A computer program, optionally stored on a computer readable medium, the program comprising computer-executable instructions for controlling a portable device to provide the functionality of a calendar application program, the portable device comprising: an output transducer; and a processor, and the calendar application program being:
operable when running on the processor to store at least first and second calendar entries, the first calendar entry having associated therewith a first media item, and the second calendar entry having associated therewith a second media item, the first media item being different to the second media item, and content provided by the first media item being different to content provided by the second media item; and
responsive to a detection that a current time corresponds to an activation time of one of the first and second calendar entries to render content provided by the associated media item via the output transducer.

12. A computer program, optionally stored on a computer readable medium, the program comprising computer-executable instructions for controlling a portable device to provide the functionality of a calendar application program, the portable device comprising: an output transducer; a memory, the memory being provided with plural media items, each media item providing content; and a processor, and the calendar application program being:
operable when running on the processor to store at least two calendar entries, each calendar entry including a respective media item identifier; and
responsive to a detection that a current time corresponds to an activation time of one of the plural calendar entries:
to extract from the memory the media item corresponding to the media item identifier stored with the calendar entry, and
to use the extracted image media item to render the content provided thereby via the output transducer.

13. A method of operating a portable device comprising: an output transducer; a processor; and a calendar application program, the method comprising:
controlling the calendar application program when running on the processor to store at least first and second calendar entries, the first calendar entry having associated therewith a first media item, and the second calendar entry having associated therewith a second media item, the first media item being different to the second media item, and content provided by the first media item being different to content provided by the second media item; and
in response to a detection that a current time corresponds to an activation time of one of the first and second calendar entries, rendering content provided by the associated media item via the output transducer.

14. A method of operating a portable device comprising: an output transducer; a memory, the memory being provided with plural media items, each media item providing content; a processor; and a calendar application program, the method comprising:
controlling the calendar application program when running on the processor to store at least two calendar entries, each calendar entry including a respective media item identifier; and
in response to a detection that a current time corresponds to an activation time of one of the plural calendar entries:
extracting from the memory the media item corresponding to the media item identifier stored with the calendar entry, and
using the extracted image media item to render the content provided thereby via the output transducer.
